(19) United States
(12) Patent Application Publication
(10) Pub. No.: US 2003/0109187 A1
(43) Pub. Date: Jun. 12, 2003

(54) Treated fabric and method and apparatus for producing same

(76) Inventor: Larry J. Cantrell SR., Flowery Branch, GA (US)

Correspondence Address: Bryan W. Bockhop, Esq., BOCKHOP & REICH, LLP, Bldg. 400, Suite 300, 3235 Satellite Blvd., Duluth, GA, 30096, US

(21) Appl. No.: 10/194,153

(22) Filed: Jul. 12, 2002

Related U.S. Application Data
(60) Provisional application No. 60/339,216, filed on Dec. 10, 2001.

(51) Int. Cl. B32B 27/12; B32B 3/00; B32B 5/02; B32B 27/02; D04H 3/16; B32B 9/00; B32B 27/04

(52) U.S. Cl. 442/123; 442/401; 442/59; 442/170; 442/171

(57) ABSTRACT

A landscaping fabric that includes a pesticide is made by extruding molten polypropylene from a plurality of holes to generate filaments. The filaments are cooled and drawn to cause the filaments to become reduced in diameter. The filaments are distributed onto a belt to form a mat and the mat is compressed to bond the filaments into a nonwoven fabric. An insecticide is applied to the nonwoven fabric and the nonwoven fabric and insecticide combination is dried.

### BACKGROUND OF THE INVENTION

1. Field of the Invention

The present invention relates to nonwoven fabric and, more specifically, to a nonwoven fabric treated with an insecticide, and an apparatus and method for producing the same.

2. Description of the Prior Art

Nonwoven fabric is made by heating bulk polymer pellets, such as polypropylene, and then extruding the molten material through spinnerettes. The polymer from the spinnerettes is next quenched to form filaments, which are drawn with high velocity air to reduce their diameter and increase orientation. The drawn filaments are distributed onto a belt to form a fiber mat. The mat is passed through a calender roll, which bonds the filaments of the mat into a fabric. Existing nonwoven fabric may be used in many applications, including as a weed barrier in landscaping and as an architectural vapor barrier.

In both landscaping and architectural applications, application of pesticides is sometimes required. This is usually done through spraying. Spraying of pesticides may be wasteful and may cause environmental problems as a result of the broadcasting nature of spraying.

Therefore, there is a need for a nonwoven fabric that has a pesticide embedded therein.

### SUMMARY OF THE INVENTION

The disadvantages of the prior art are overcome by the present invention which, in one aspect, is a method of making a landscaping fabric. A molten polypropylene is extruded from a plurality of holes to generate filaments. The filaments are cooled and drawn to cause the filaments to become reduced in diameter. The filaments arc distributed onto a belt to form a mat and the mat is compressed to bond the filaments into a nonwoven fabric. An insecticide is applied to the nonwoven fabric and the nonwoven fabric and insecticide combination is dried.

In another aspect, the invention is a landscaping fabric that includes a nonwoven polypropylene fabric, to which bifenthrin is applied.

In yet another aspect, the invention is an apparatus for manufacturing a treated fabric in which a hopper stores a bulk material. An extruder receives the bulk material from the hopper and melts the bulk material. The material passed from the extruder to a pump to a spin pack which contains a spinnerettes having a plurality of holes that form a plurality of filaments. A quench region receives the plurality of filaments from the spinnerette and allows the plurality of filaments to cool to a substantially non-molten state. A plurality of air jets receive the plurality of filaments from the quench region and draw the plurality of filaments so as to narrow and extend each of the plurality of filaments. A plurality of distribution flaps receive the plurality of filaments from the plurality of airjets and distributes the plurality of filaments onto a conveyor belt as a substantially evenly distributed mat. Two heated rolls compress the mat into a fabric. A treatment applicator applies a treatment substance to the fabric and a dryer dries the treatment substance onto the fabric.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

BRIEF DESCRIPTION OF THE FIGURES OF THE DRAWINGS

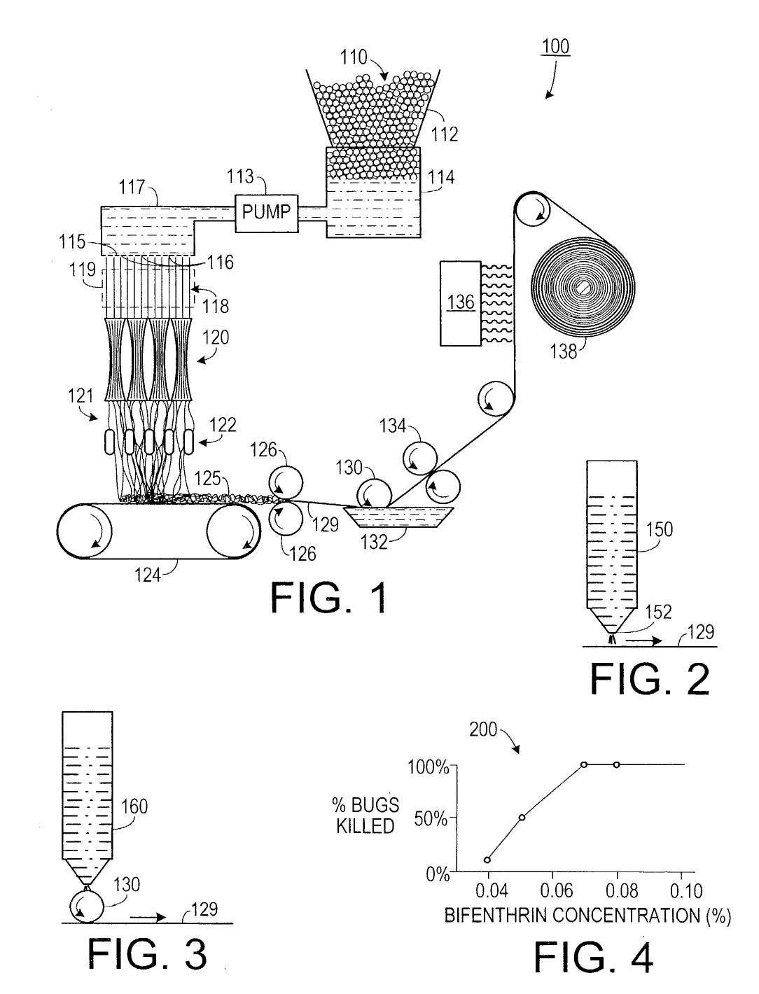

FIG. 1 is a schematic diagram generally showing a process for producing an insecticide-treated fabric, according to one aspect of the invention.

FIG. 2 is a schematic diagram of an alternate method of applying a treatment to a fabric.

FIG. 3 is a schematic diagram of a second alternate method of applying a treatment to a fabric.

FIG. 4 is a graph relating percentage of insects killed by a fabric according to the invention in relation to pesticide concentration, as determined in one production trial.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

As shown in FIG. 1, one illustrative embodiment of an apparatus 100 for manufacturing a treated fabric according to the invention includes a hopper 112 that stores a bulk material, such as polypropylene pellets 110. An extruder 114 receives the pellets 110 from the hopper 112 and melts them. The molten material passes to a pump 113 then into a spin pack 117, which includes a spinnerette 115 that defines a plurality of holes 116. The plurality of holes 116 form a plurality of filaments 118 made of molten polypropylene. The filaments 118 are passed through a quench region 119 that allows the filaments 118 to cool to a substantially non-molten state. A plurality of air jets 120 draw the filaments 118 so as to reduce their diameter. A plurality of distribution flaps 122 distribute the drawn filaments 121 onto a conveyor belt 124 as a substantially evenly distributed mat 125. Calendar rolls 126 compress the mat 125 into a spunbond fabric 129. The fabric 129 is passed through a treatment bath 132, containing a treatment such as a pesticide in solution, and then passed through a wringer 134.

The fabric 129 is then passed through a dryer 136 so that the treatment dries onto the fabric 129. The dryer 136 forces air through the treated fabric 129. The drying temperature may be varied, depending upon the thickness of the fabric 129 and the type of treatment used. The fabric 129 is then rolled into a roll 138. The final treated fabric may be used in landscaping applications, as an architectural vapor barrier (e.g., in crawl spaces) and in many applications in which having an insecticide applied locally is desirable.

In an alternate embodiment, as shown in FIG. 2, the treatment may be sprayed onto the fabric 129 using a treatment reservoir 150 that supplies the treatment to a spray nozzle 152, or a plurality thereof. In another embodiment, as shown in FIG. 3, a treatment reservoir 160 applies the treatment directly to the kiss roller 130, which then applies the treatment to the fabric 129.

In one embodiment of the fabric used as a pesticidal landscaping fabric, the pesticide could include bifenthrin, which includes the following, aromatic hydrocarbons; 1,2,4-trimethylbenzene; xylene, surfact blend; ethylbenzene; curnene; and 1-butanol. Bifenthrin is the main active ingredient of several commonly available pesticides, including Capture®, Talstar®, and Brigade®. The bifenthrin, in the form that it is applied to the fabric, is preferably in a concentration within a range of between 0.02 percent bifenthrin and 0.50 percent bifenthrin with the remainder of the treatment being water. Preferably, the concentration of the applied bifenthrin will be between 0.07 percent bifenthrin and 0.20 percent bifenthrin, as concentrations of less than 0.07 percent are not as effective in killing insects. However, it should be noted that in some applications, a concentration of less than 0.07 percent bifenthrin may be desirable. When using bifenthrin, the temperature of the air in the dryer 136, using 34 gram per square meter fabric, should be about 80° C., which is well below the flashpoint of bifenthrin.

In one production trial the several different concentrations (0.04%, 0.05%, 0.07%, 0.08%, and 0.14%) of bifenthrin in water were applied to 34 gsm black spunbond nonwoven polypropylene fabric at a 140% wet pick up rate. The samples were passed through a padder and then passed through a tenter frame dryer at 80° C. with a dwell time of 2 minutes. Each of these samples was placed in a container with 10 crickets. A graph 200 demonstrating the results of these tests is shown in FIG. 4.

In other applications of the invention, the treatment could include one of the following: a fungicide; an animal repellent (to prevent animals from digging up a garden); an anti-bacterial agent (for use in health care applications); or even a meat preservative, such as Goop® (to wrap meat). Any combinations of these treatments could also be used, depending on the specific application of the invention.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A method of making a landscaping fabric, comprising the steps of:
a. extruding molten polypropylene from a plurality of holes to generate filaments;
b. cooling the filaments;
c. drawing the filaments to cause the filaments to become reduced in diameter;
d. distributing the filaments onto a belt to form a mat;
e. compressing the mat to bond the filaments, thereby forming a nonwoven fabric;
f. applying an insecticide to the nonwoven fabric; and
g. drying the nonwoven fabric with the insecticide applied thereto.

2. The method of claim 1, wherein the applying step comprises applying bifenthrin to the nonwoven fabric.

3. The method of claim 2, wherein the bifenthrin is mixed with water and applied at a concentration within a range of between 0.02 percent bifenthrin and 0.5 percent bifenthrin.

4. The method of claim 3, wherein the bifenthrin is applied at a concentration within a range of between 0.07 percent bifenthrin and 0.2 percent bifenthrin.

5. The method of claim 1, wherein the applying step comprises passing the nonwoven fabric through a bath of the insecticide.

6. The method of claim 1, wherein the applying step comprises spraying the insecticide onto the nonwoven fabric.

7. The method of claim 1, further comprising the step of rolling the nonwoven fabric onto a roll.

8. A landscaping fabric, comprising:
a. a nonwoven polypropylene fabric; and
b. bifenthrin applied to the nonwoven polypropylene fabric.

9. The landscaping fabric of claim 8, wherein the nonwoven polypropylene fabric comprises a spunbond fabric.

10. An apparatus for manufacturing a treated fabric, comprising:
a. a hopper that stores a bulk material;
b. an extruder that receives the bulk material from the hopper and that melts the bulk material, thereby generating molten bulk material,
c. a spin pack that receives the molten bulk material from the extruder, the spin pack including a spinnerette that defines a plurality of holes that form a plurality of filaments from the molten bulk material;
d. a quench region that receives the plurality of filaments from the bottom plate and allows the plurality of filaments to cool to a substantially non-molten state;
e. a plurality of air Jets that receive the plurality of filaments from the quench region and that draw the plurality of filaments so as to narrow each of the plurality of filaments;
f. a conveyor belt,
g. a plurality of distribution flaps that receive the plurality of filaments from the plurality of air jets and that distribute the plurality of filaments onto the conveyor belt and into a substantially evenly distributed mat;
h. at least one calender roll that compresses the mat into a fabric;
i. a treatment applicator that applies a treatment substance to the fabric; and
j. a dryer that dries the treatment substance onto the fabric.

11. The apparatus of claim 10, wherein the treatment applicator comprises a treatment material bath through which the fabric is passed.

12. The apparatus of claim 10, wherein the treatment applicator comprises a sprayer.

13. The apparatus of claim 10, wherein the treatment applicator comprises:
a. a treatment reservoir that holds the treatment;
b. a kiss roll that receives the treatment from the treatment reservoir and that applies the treatment to the fabric.

14. The apparatus of claim 10, wherein the bulk material comprises polypropylene pellets.

15. The apparatus of claim 10, wherein the treatment substance includes a pesticide.

16. The apparatus of claim 15, wherein the pesticide comprises bifenthrin.

17. The apparatus of claim 16, wherein the bifenthrin is mixed with water and applied at a concentration within a range of between 0.02 percent bifenthrin and 0.5 percent bifenthrin.

18. The apparatus of claim 17, wherein the bifenthrin is applied at a concentration within a range of between 0.07 percent bifenthrin and 0.2 percent bifenthrin.

19. The apparatus of claim 10, wherein the treatment substance includes a fungicide.

20. The apparatus of claim 10, wherein the treatment substance includes an animal repellent.

21. The apparatus of claim 10, wherein the treatment substance includes an antibacterial agent.

22. The apparatus of claim 10, wherein the treatment substance includes a meat preservative.
